(19) United States
(12) Patent Application Publication
(10) Pub. No.: US 2026/0007093 A1
(43) Pub. Date: Jan. 8, 2026

(54) SEEDING IMPLEMENT WITH SENSORS

(71) Applicant: Great Plains Manufacturing, Inc., Salina, KS (US)

(72) Inventor: Lars William Peterson, Lindsborg, KS (US)

(21) Appl. No.: 18/763,592

(22) Filed: Jul. 3, 2024

(51) Int. Cl. A01C 7/20; A01C 21/00

(52) U.S. Cl. CPC A01C 7/205; A01C 21/005

(57) ABSTRACT

It has been discovered that seeding implements may better manage and mitigate seed bounce during seed application by incorporating an image sensor and a seed flow sensor within the seeding implement, which can be used to control a pressure differential device, such as a fan, associated with the seeding implement. More particularly, based on the information provided by the image sensor and/or the seed flow sensor, a controller can adjust the operation of the pressure differential device of the seeding implement, thereby better controlling and mitigating seed bounce by the seeding implement during seed application. Thus, an effective control loop for controlling seed bounce can be created with the image sensor and a seed flow sensor.

### BACKGROUND

### 1. Field of the Invention

The present invention relates generally to seeding implements for agricultural applications. More specifically, embodiments of the present invention generally concern seeding implements that utilize various sensors.

### 2. Description of the Related Art

Agricultural seeders and planters are well known for distributing crop seeds uniformly along a field. Generally, conventional seeders and planters are configured to deposit rows of seed by opening a series of furrows, depositing seed in the furrows, and then closing the furrows. Typically, such machines include seed metering devices to dispense seed to the furrows at a predetermined rate.

However, conventional seeding equipment has various disadvantages. For instance, conventional seeding implements are generally prone to inaccurate dispensing of seed. Previously, to address this issue, sensors have been used to count seeds that are directed to a furrow. Unfortunately, these sensor arrangements, particularly in air seeders, have been unable to adequately address the issue concerning seed bounce during seed application. It is known that some seeds will roll or bounce as they transition from the transferring device and enter the soil furrow. Nevertheless, conventional sensors have been unable to sense or capture the effect of roll or bounce on final seed location.

Accordingly, there is still a need for seeding implements that can better prevent seed bounce during application.

### SUMMARY

One or more embodiments of the present invention generally concern a seeding implement for depositing seeds. Generally, the seeding implement comprises: a furrow opener configured to create a furrow in the ground; a seed distribution assembly configured to deposit seeds in the furrow; a pressure differential device configured to provide air pressure to the seed distribution assembly; an image sensor configured to obtain information indicative of one or more seed parameters of the seeds already deposited in the furrow; and a controller configured to process the information obtained by the image sensor, wherein the controller is further configured to automatically control operation of the pressure differential device based on the one or more seed parameters.

One or more embodiments of the present invention generally concern a seeding implement for depositing seeds. Generally, the seeding implement comprises: a furrow opener configured to create a furrow in the ground; a seed source configured to store seeds; a seed distribution assembly configured to deposit the seeds in the furrow, wherein the seed distribution assembly comprises a seed conduit operably connected to the seed source, wherein the seed conduit facilitates transportation of the seeds from the seed source; a seed flow sensor configured to obtain flow information indicative of a flow of the seeds in the seed conduit; a pressure differential device configured to provide air pressure to the seed distribution assembly; an image sensor configured to obtain seed information indicative of one or more seed parameters of the seeds already deposited in the furrow; and a controller configured to process the flow information from the seed flow sensor and the seed information from the image sensor, wherein the controller is further configured to automatically control operation of the pressure differential device based on the flow information and the seed information. Typically, the pressure differential device comprises a pneumatic pump, an air compressor, a vacuum pump, or a fan.

One or more embodiments of the present invention generally concern an agricultural system. Generally, the agricultural system comprises: a frame configured to be transported by a tractor; a furrow opener configured to create a furrow in the ground; a seed source configured to store seeds; a seed distribution assembly configured to deposit the seeds in the furrow, wherein the seed distribution assembly comprises a seed conduit operably connected to the seed source, wherein the seed conduit facilitates transportation of the seeds from the seed source; a seed flow sensor configured to obtain flow information indicative of a flow of the seeds in the seed conduit; a pressure differential device configured to provide air pressure to the seed distribution assembly; an image sensor configured to obtain seed information indicative of one or more seed parameters of the seeds already deposited in the furrow; a user interface; and a controller comprising a processing element and a memory element. Furthermore, the controller is configured to: receive, via the user interface, one or more target settings for seed distribution; obtain, via the image sensor and the seed flow sensor, the flow information and the seed information; compare the flow information and the seed information with the target settings; and adjust operating characteristics of the pressure differential device based on comparison between the target settings and the flow information and the seed information. Typically, the pressure differential device comprises a pneumatic pump, an air compressor, a vacuum pump, or a fan.

One or more embodiments of the present invention generally concern a method for mitigating seed bounce during seed application. Generally, the method comprises: (a) applying one or more seeds into a furrow via a seeding implement; (b) observing the seed bounce during the seed application; and (c) adjusting the air pressure provided by the pressure differential device based on the observing of step (b). Furthermore, the seeding implement generally comprises: a furrow opener configured to create the furrow in the ground; a seed source configured to store seeds; a seed distribution assembly configured to deposit the seeds in the furrow, wherein the seed distribution assembly comprises a seed conduit operably connected to the seed source, wherein the seed conduit facilitates transportation of the seeds from the seed source; a seed flow sensor configured to obtain flow information indicative of a flow of the seeds in the seed conduit; a pressure differential device configured to provide air pressure to the seed distribution assembly, wherein the pressure differential device comprises a pneumatic pump, an air compressor, a vacuum pump, or a fan; an image sensor configured to obtain seed information indicative of one or more seed parameters of the seeds already deposited in the furrow; and a controller configured to process the flow information from the seed flow sensor and the seed information from the image sensor.

### BRIEF DESCRIPTION OF THE FIGURES

Embodiments of the present invention are described herein with reference to the following drawing figures, wherein:

FIG. 1 is a right side elevational view of a seeding implement according to embodiments of the present invention in the form of an air seeder utilizing seed distribution manifolds/towers;

FIG. 2 is a top elevational view of the seeder from FIG. 1;

FIG. 3 is a top rear perspective view of the seeder from FIG. 1;

FIG. 4 is a right side view of the seeder from FIG. 1 with an opener removed for visual depiction of the seed tube;

FIG. 5 is a left, front perspective view of an alternative seeding implement according to embodiments of the present invention in the form of an air seeder utilizing seed distribution manifolds/towers;

FIG. 6 is a left side elevational view of the seeder from FIG. 5;

FIG. 7 is a top rear perspective view of an alternative seeding implement according to embodiments of the present invention in the form of a plurality of row units each comprising a seed meter;

FIG. 8 is a bottom rear perspective view of the seeding implement from FIG. 7;

FIG. 9 is a perspective view of a pair of row units that may be used with the seeding implement from FIG. 7;

FIG. 10 is a partial right-side perspective view of a seed meter from a row unit of the seeding implement from FIG. 7, with a side of a housing removed to illustrate a metering disc within the housing;

FIG. 11 is a fragmentary schematic elevational view of a seeding implement constructed in accordance with one or more embodiments of the present invention, showing an opener assembly used to deposit seeds into a furrow via a seed tube, and an image sensor to obtain information about the deposited seed; and

FIG. 12 is a schematic view of a controller operably coupled to a seed flow sensor, an image sensor, an optional user interface, and a pressure differential device.

The drawing figures do not limit the present invention to the specific embodiments disclosed and described herein. While the drawings do not necessarily provide exact dimensions or tolerances for the illustrated components or structures, the drawings, not including any purely schematic drawings, are to scale with respect to the relationships between the components of the structures illustrated therein.

### DETAILED DESCRIPTION

It has been discovered that seeding implements may better manage and mitigate seed bounce during application by utilizing an image sensor and a seed flow sensor, which can be used to control a pressure differential device, such as a fan, associated with the seeding implement. More particularly, a controller can adjust the operation of the pressure differential device based on the information provided by the image sensor and/or the seed flow sensor, thereby mitigating and preventing seed bounce by the seeding implement during seed application.

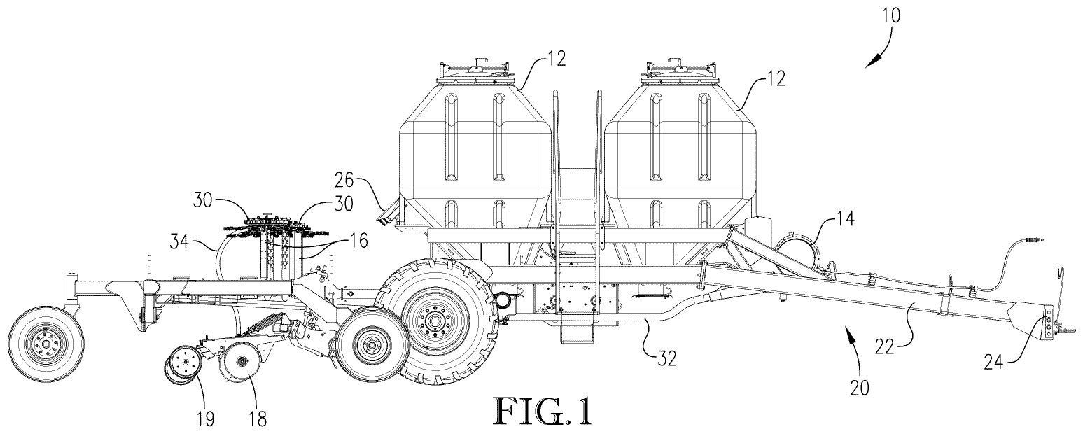

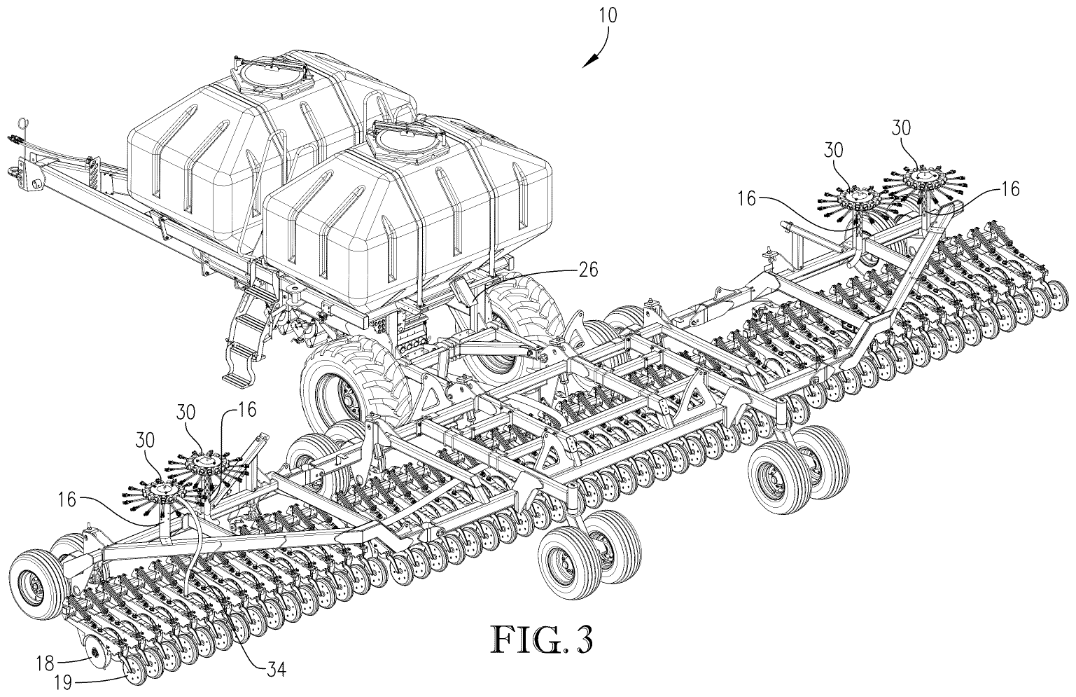

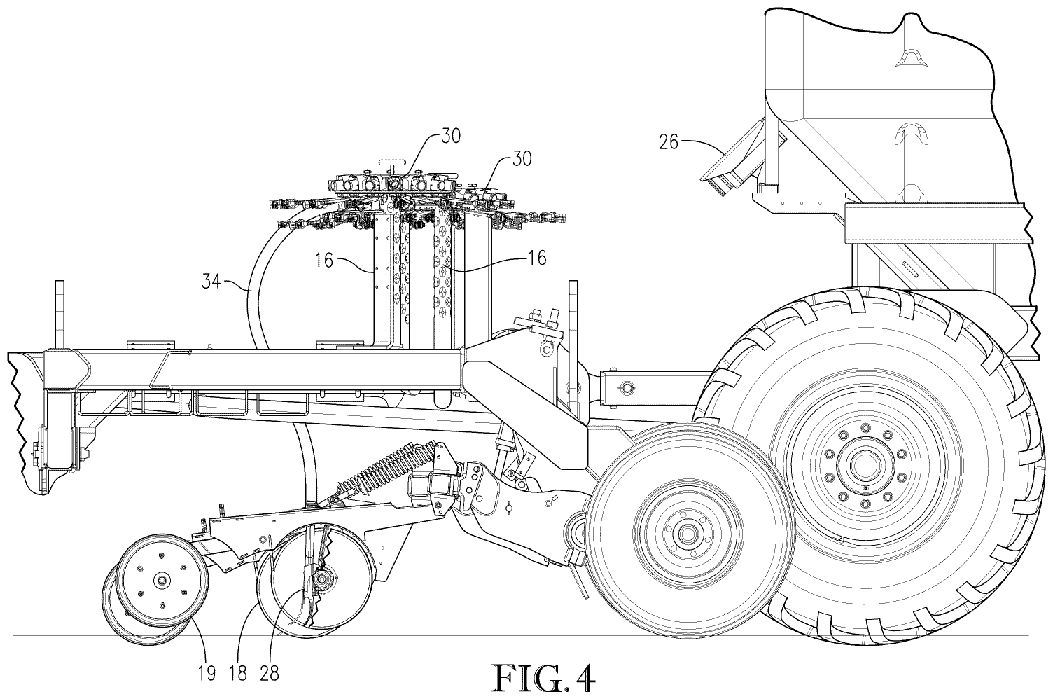

The present invention broadly provides various embodiments of an agricultural planting system, device, and method of use. In more detail, and with reference to FIGS. 1-4, embodiments of the present invention may comprise a seeding implement 10 in the form of an air seeder that includes at least one bin 12 for holding various types of seeds, a pressure differential device 14 for producing an air-pressure differential within the system, one or more distribution manifolds 16 (e.g., the vertically extending distribution towers depicted in FIGS. 1-6) operable to receive seed from the bin(s) 12 and distribute the seeds, one or more openers 18 (e.g., coulter blades shown in FIGS. 1-6) for forming furrows in the ground, and one or more closing wheels 19 for closing the furrows.

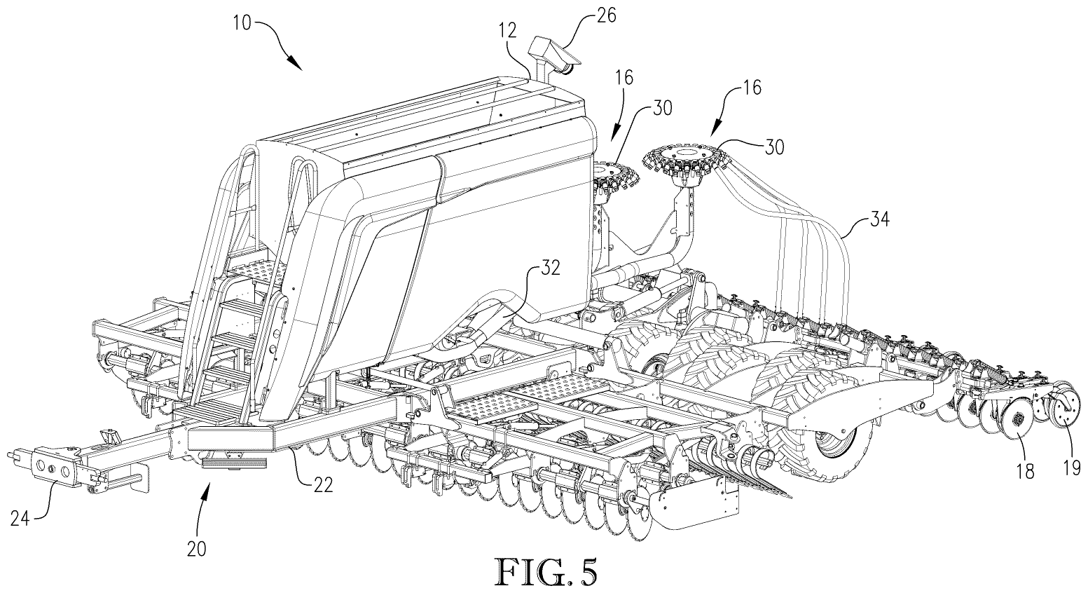

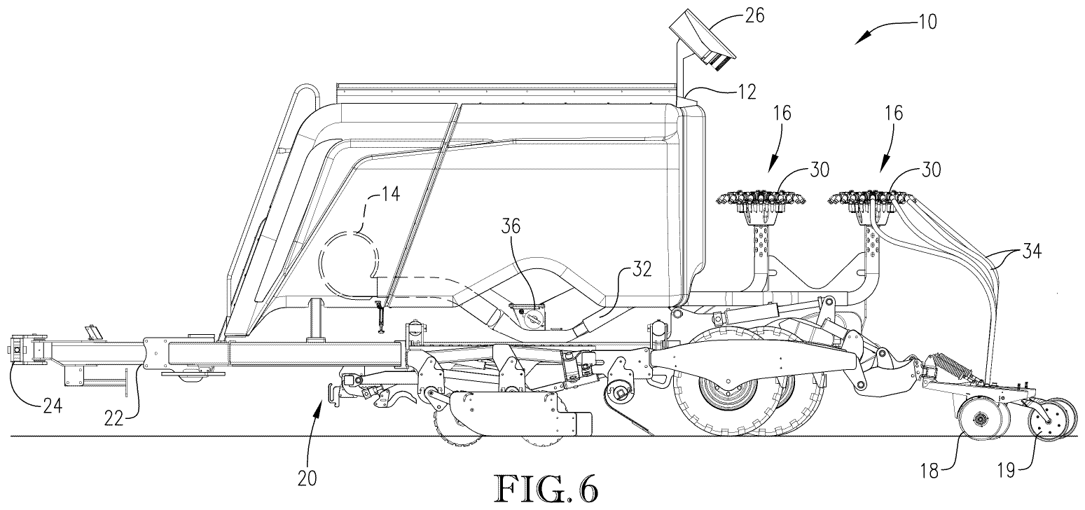

In an alternative embodiment described below in greater detail, and as depicted in FIGS. 5 and 6, the seeding implement 10 may comprise a different air seeder that also utilizes distribution manifolds 16 to distribute the seeds.

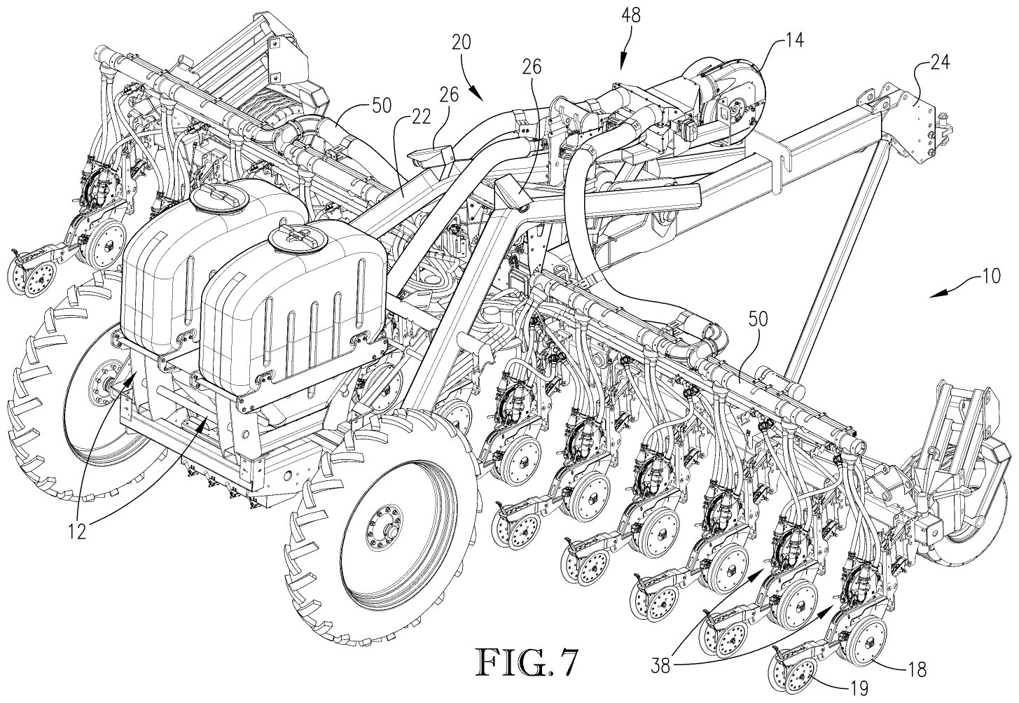

In an alternative embodiment described below in greater detail, and as depicted in FIGS. 7-10, embodiments of the present invention may comprise a seeding implement 10 that includes at least one bin 12 for holding various types of seeds, a pressure differential device 14 for producing an air-pressure differential within the system, one or more row units comprising seed meters 38 operable to receive seed from the bin(s) 12 and meter the seeds in a controlled manner into the ground soil of a field for planting, one or more openers 18 for forming furrows in the ground, and one or more closing wheels 19 for closing the furrows. Additionally, the seed dispensing tube 28 associated with each meter may contain a conduit 40 associated with the pressure differential device 14 that can create a positive pressure differential within the tube 28, thereby facilitating the disbursement of the seed from the tube 28 after the meter 38.

The components of the seeding implement systems may be mounted on a seed planting machine 20 that broadly comprise a frame 22 and a hitch assembly 24. As such, the seed planting machine 20 can be connected to a towing unit (e.g., a tractor) for pulling or pushing the seed planting machine 20 during operation. Exemplary seed planting machines, seed meters, and air seeders are described in U.S. Pat. App. Pub. No. 2018/0338410 and U.S. Pat. No. 11,751,502, which are herein incorporated by reference in their entireties. As described below in greater detail, at least one image sensor 26 may be positioned on the frame 22 and/or seed bin 12. Multiple image sensors 26 may be preferred in certain circumstances, particularly when the seeding implement 10 is very wide. In the case of a wide implements 10, multiple image sensors 26 can be used to regulate airflow differently in different sections based on the distance between the meter 38 and the opener 18.

In operation, all of the seeding implements 10 described herein are operable to dispense seeds onto a field in an efficient and controlled manner.

### Air Seeding Implements Containing Distribution Manifolds

As shown in FIGS. 1-4, the seed planting machine 20 may include a plurality of seed distribution manifolds 16 with distribution heads 30 attached to the frame 22. In more detail, each of the seed distribution manifolds 16 is configured for dispensing seeds into or onto the ground soil via a seed dispensing tube 28.

The operations of air drills are described in U.S. Pat. No. 11,751,502, the entire disclosure of which is incorporated herein by reference.

Turning to FIGS. 1-4, the seeding implement 10 comprises at least two seed bins 12 in the form of a hopper supported on the main frame 22 for holding a supply of seeds, fertilizer, or other particulate materials to be distributed. A meter at the bottom of the hopper(s) 12 may be utilized to dispense seeds at a metered rate into one or more seed conduits 32 (e.g., piping, tubing, hose, conduits, or the like) that transport the metered seeds within a primary stream toward the rear of the seeder 10. One or more distribution manifolds 16 may be coupled with conduits 32 downstream from the meter for the purpose of dividing each primary stream of seeds into a multiplicity of secondary streams that flow to the seed tubes 28 through secondary seed conduits 34 (e.g., piping, tubing, hose, conduits, or the like). A pressure differential device 14, such as a blower (i.e., fan) adjacent the lower front end of a hopper 12 supplies the transporting air for conduits 32, 34. As is used herein, the term “downstream” means a direction of air/seed flowing through the seeder 10 away from the blower 14, while “upstream” means a direction of air/seed flowing through the seeder towards the blower 14.

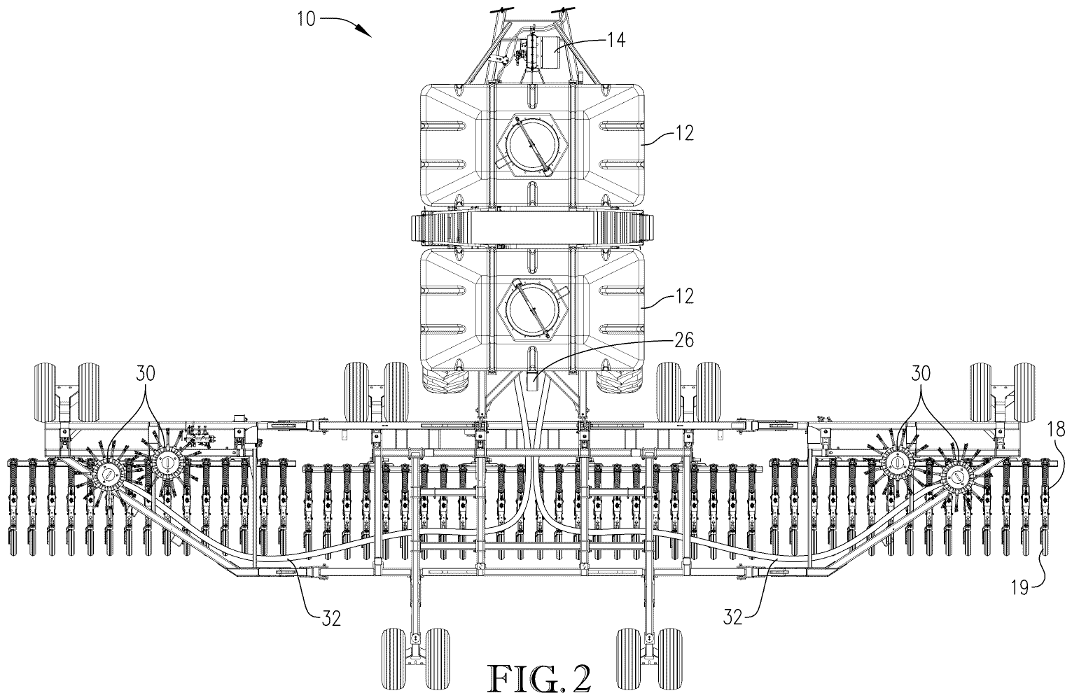

Each of the distribution manifolds 16 may include an upright pipe or conduit fixed to the frame and connected at its lower end to the conduit 32 from hopper 12 (see, FIG. 2). A generally cylindrical distribution head 30 may be secured to the upper end of upright conduit for splitting the primary stream of air and seed that flows upward through the upright conduit (from the conduit 32 extending from the hopper 12) into the secondary streams of air and seed (via secondary seed conduits 34) that transition the direction of the air and seed flow from generally vertical to generally horizontal.

An image sensor 26 may be positioned at any point on the frame 22 or any other position deemed desirable for vantage points. In FIGS. 1-4, the image sensor 26 is positioned near the bin (hopper) 12 so as to provide the best vantage point of the furrows for the image sensor 26.

The pressure differential device 14 powering the air seeder in FIGS. 1-4 can comprise a pneumatic pump, an air compressor, a vacuum pump, a fan, or the like, for facilitating transportation of the seeds fed from the bin 12, through the primary seed conduits 32. the secondary seed conduits 34, and into the seed tubes 28 that distribute the seeds into the furrows.

Additionally, a seed flow sensor may be incorporated on and/or within the primary seed conduits 32, the secondary seed conduits 34, and/or the seed dispensing tube 28. The seed flow sensor may be configured to monitor seed flow within the primary seed conduits 32, the secondary seed conduits 34, and/or the seed dispensing tube 28 and determine if the flow of seeds have ceased or decreased in the conduits and/or tube. In one or more embodiments, the seed flow sensor may comprise a physical measuring device, such as a flap and/or a shutter. Additionally, or in the alternative, the seed flow sensor may be an optical sensor, a time-of-flight sensor, such as a LiDAR sensor, a radar sensor, an ultrasonic sensor, piezoelectric sensor, acoustic sensor, and/or a sonar sensor. In more detail, the seed flow sensor may comprise a pair of photocells arranged in diametrically opposed locations for transmitting a light beam across the conduits or tubes. One of the cells may be a sender and the other may be a receiver. Breaking of the light beam by moving seeds may be utilized to confirm the amount of seed being transported through the conduits or tubes.

Alternatively, blockage of seed flow within the primary seed conduits 32, the secondary seed conduits 34, and/or the seed dispensing tube 28 may be monitored and identified by the seed flow sensors using: (i) human crafted, traditional machine vision algorithms, and (ii) deep-learning, neural network methods of computer-optimized algorithms for object detection. These algorithms are configured to be processed by the controller, which may include an electronic control unit (ECU) computer, as described below.

Although not depicted in FIGS. 1-4, the seed flow sensors may be positioned at any position within the primary seed conduits 32, the secondary seed conduits 34, and/or the seed dispensing tube 28. In one or more embodiments, the seeding implement may comprise a plurality of seed flow sensors, such as at least two, three, four, five, six, or seven sensors, positioned throughout the primary seed conduits 32, the secondary seed conduits 34, and/or the seed dispensing tube 28. Each of the sensors may be configured to monitor seed flow at their designated position.

FIGS. 5 and 6 depict an alternative embodiment of an air seeder of the present disclosure. It should be noted that the components listed with the same numerals in FIGS. 5 and 6 are assumed to operate in the same or similar manner as described above in regard to FIGS. 1-4, unless otherwise specified.

As shown in FIG. 6, a meter 36 at the bottom of hopper 12 may be utilized to dispense seeds at a metered rate into one or more seed conduits 32 that transport the metered seeds within a primary stream toward the rear of the seeder 10. One or more distribution manifolds 16 may be coupled with conduits 32 downstream from meter 36 for the purpose of dividing each primary stream of seeds into a multiplicity of secondary streams that flow to the seed tubes 28 through secondary seed conduits 34. A pressure differential device 14, such as a blower (i.e., fan) adjacent the lower front end of hopper 12 supplies the transporting air for conduits 32, 34.

An image sensor 26 may be positioned at any point on the frame 22 or any other position deemed desirable for vantage points. In FIGS. 5 and 6, the image sensor 26 is positioned on the bin (hopper) 12 so as to provide the best vantage point of the furrows for the image sensor 26.

The pressure differential device 14 powering the air seeder in FIGS. 5 and 6 can comprise a pneumatic pump, an air compressor, a vacuum pump, a fan, or the like, for facilitating transportation of the seeds fed from the bin 12, through the seed conduits, and into the seed tubes 28 that distribute the seeds into the furrows.

Additionally, a seed flow sensor may be incorporated on and/or within the primary seed conduits 32, the secondary seed conduits 34, and/or the seed dispensing tube 28. The seed flow sensor may be configured to monitor seed flow within the primary seed conduits 32, the secondary seed conduits 34, and/or the seed dispensing tube 28 and determine if the flow of seeds have ceased or decreased in the conduits and/or tube.

Alternatively, blockage of seed flow within the primary seed conduits 32, the secondary seed conduits 34, and/or the seed dispensing tube 28 may be monitored and identified by the seed flow sensors using: (i) human crafted, traditional machine vision algorithms, and (ii) deep-learning, neural network methods of computer-optimized algorithms for object detection. These algorithms are configured to be processed by the controller, which may include an electronic control unit (ECU) computer, as described below.

Although not depicted in FIGS. 5 and 6, the seed flow sensors may be positioned at any position within the primary seed conduits 32, the secondary seed conduits 34, and/or the seed dispensing tube 28. In one or more embodiments, the seeding implement may comprise a plurality of seed flow sensors, such as at least two, three, four, five, six, or seven sensors, positioned throughout the primary seed conduits 32, the secondary seed conduits 34, and/or the seed dispensing tube 28. Each of the sensors may be configured to monitor seed flow at their designated position.

### The Seeding Implement Containing Seed Meters

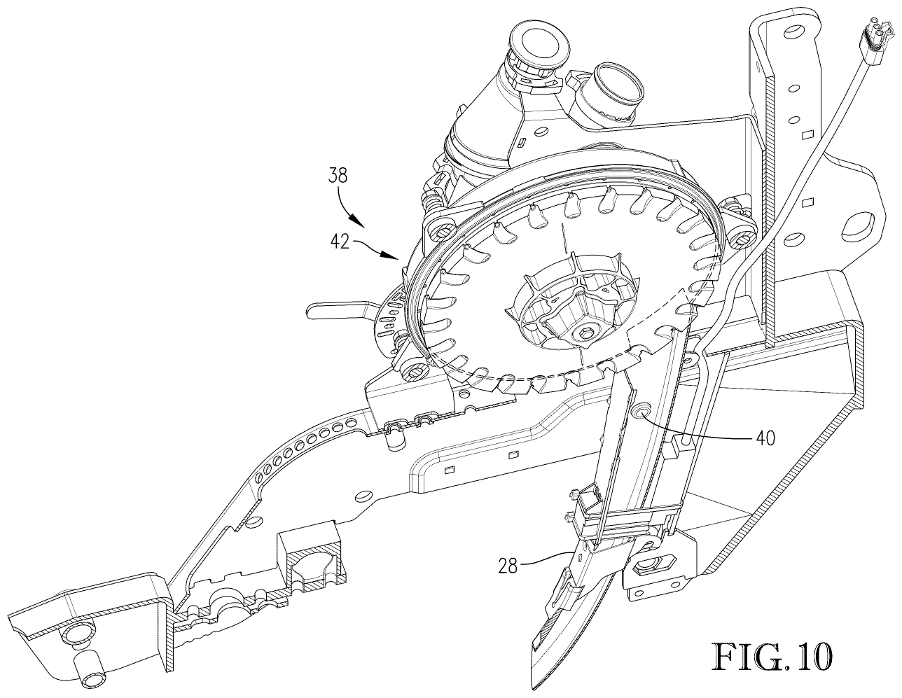

An alternative embodiment is depicted in FIGS. 7-10, wherein the seed planting machine 20 may include a plurality of row units comprising seed meters 38, rather than seed distribution manifolds/towers, attached to the frame 22. In more detail, each of the seed meters 38 is configured for dispensing seeds one at a time into the ground soil via a seed dispensing tube 28. A goal of the seed meters 38 is to singulate and drop seeds in a way that provides a desired number of seeds per acre and a uniform spacing between the seeds as they are placed in the ground soil. Additionally, as shown in FIG. 10, a conduit 40 may be in fluid communication with the pressure differential device 14 so as to generate air flow and facilitate the disbursement of the seeds from the seed tube 28, after the seed meter 38.

It should be noted that the components listed with the same numerals in FIGS. 1-6 are assumed to operate in the same or similar manner in FIGS. 7-10, unless otherwise specified.

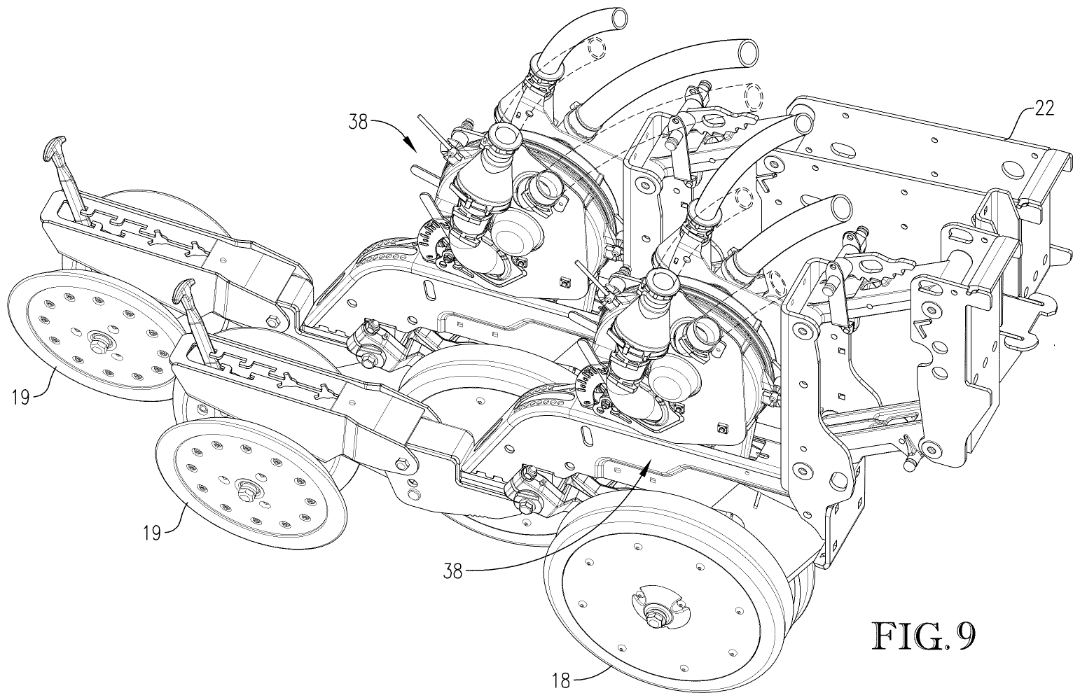

In one or more embodiments, the seed planting machine 20 may include at least four row units, at least eight row units, at least twelve row units, or at least twenty row units. The row units may be individually mounted to the frame 22. In such a configuration, the seed planting machine is configured to dispense seed in a plurality of single rows within the ground soil. Alternatively, dual row units may be mounted to the frame 22 in pairs, as shown in FIG. 9.

Turning to the row unit in more detail, and with reference to FIG. 10, the seed meter 38 generally comprises a circular housing 42. The seed meter 38 is configured to receive seed via seed inlets and is configured to receive and/or discharge air via air inlets. In such embodiments, the seed meter 38 may be operable to disseminate more than two types of seeds.

The sides of the housing 42 may be connected together via various means of connection such as clips, clasps, fasteners, hinges, or the like.

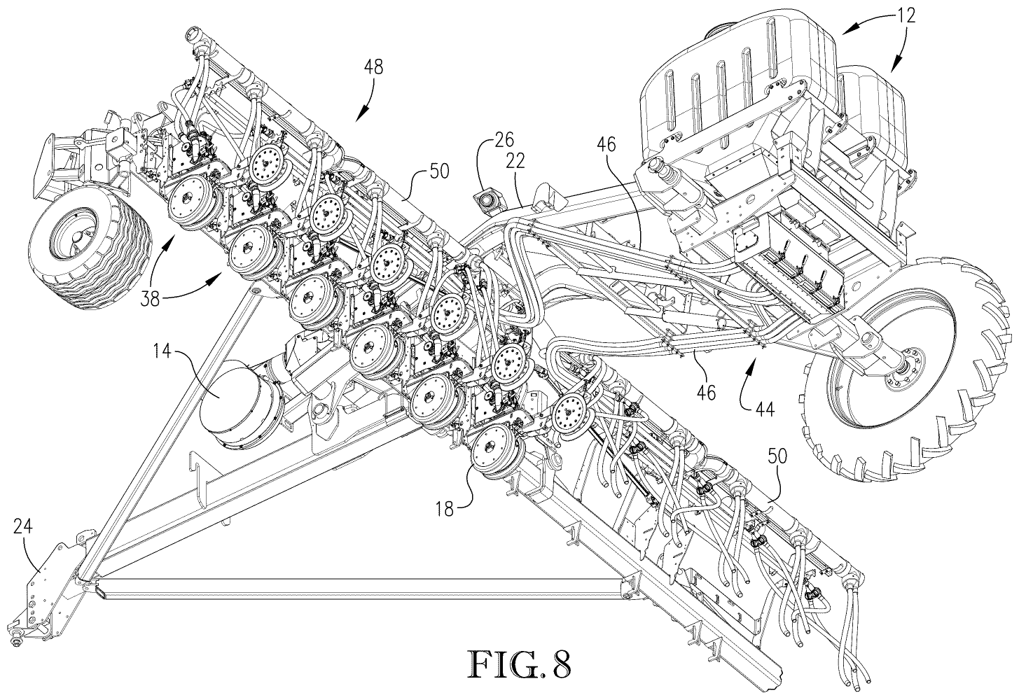

Turning back to FIGS. 7 and 8, the seeding implement 10 includes at least one bin 12 capable of holding one or more types of seeds. In some embodiments, the seeding implement 10 will include a plurality of bins 12, with each bin 12 in the operable to hold a different type of seed.

Regardless of how many bins 12 are included in the seeding implement 10, the system 10 will include, as best illustrated by FIG. 8, a seed transportation system 44 that extends from the bins 12 to each of the one or more meters 38. The seed transportation system 44 may include seed conduits 46 (e.g., piping, tubing, hose, conduits, or the like) configured to pass seeds from the bins 12 to the seed meters 38. In one or more embodiments, the seed transportation system 44 may include a plurality of individual seed conduits 46 for directing each type of seed to each of the seed meters 38.

In one or more embodiments, the seed transportation system 44 will be associated with the pressure differential device 14, which can comprise a pneumatic pump, an air compressor, a vacuum pump, a fan, or the like, for facilitating transportation of the seeds fed from the bin 12, through the seed conduits 46, and into the seed meters 38. For instance, the pressure differential device 14 may be configured to create a positive air-pressure near an outlet of the bins 12 so as to facilitate transportation of the seeds from the bins 12, through the seed conduits 46, and into the seed meters 38.

Additionally, in one or more embodiments and as depicted in FIG. 10, the pressure differential device 14 may be associated with the seed dispensing tube 28 via conduit 40. In such embodiments, the pressure differential device 14 may provide pneumatic air flow to the seed tube 28 so as to facilitate the distribution of the seeds from the tube 28.

In one or more embodiments, a seed flow sensor may be incorporated on and/or within the seed conduits 46 and/or the seed dispensing tube 28. The seed flow sensor may be configured to monitor seed flow within the seed conduits 46 and/or the seed dispensing tube 28 and determine if the flow of seeds have ceased or decreased in the conduits 46 and/or tube 28. In one or more embodiments, the seed flow sensor may comprise a physical measuring device, such as a flap and/or a shutter. Additionally, or in the alternative, the seed flow sensor may be an optical sensor, a time-of-flight sensor, such as a LiDAR sensor, a radar sensor, an ultrasonic sensor, piezoelectric sensor, acoustic sensor, and/or a sonar sensor. In more detail, the seed flow sensor may comprise a pair of photocells arranged in diametrically opposed locations for transmitting a light beam across the conduits or tubes. One of the cells may be a sender and the other may be a receiver. Breaking of the light beam by moving seeds may be utilized to confirm the amount of seed being transported through the conduits or tubes.

Alternatively, blockage of seed flow within the seed conduits 46 and/or seed tube 28 may be monitored and identified by the seed flow sensors using: (i) human crafted, traditional machine vision algorithms, and (ii) deep-learning, neural network methods of computer-optimized algorithms for object detection. These algorithms are configured to be processed by the controller, which may include an electronic control unit (ECU) computer, as described below.

Although not depicted in FIGS. 7 and 8, the seed flow sensors may be positioned at any position within the seed conduits 46 and/or the seed dispensing tube 28. In one or more embodiments, the seeding implement may comprise a plurality of seed flow sensors, such as at least two, three, four, five, six, or seven sensors, positioned throughout the seed conduits 46 and/or the seed tubes 28. Each of the sensors may be configured to monitor seed flow at their designated position.

Remaining with FIGS. 7 and 8, the seeding implement 10 may additionally include a pneumatic system 48 for producing an air-pressure differential within various portions of the system 10. In some embodiments, the pneumatic system 48 will include a pressure differential device, which may comprise a pneumatic pump, an air compressor, a vacuum pump, a fan, or a combination thereof. In certain embodiments, the pressure differential device comprises a fan. In various embodiments, the pneumatic system 48 will be associated with the pressure differential device 14, as shown in FIGS. 7 and 8. In such embodiments, the pressure differential device 14 may be commonly associated with both the pneumatic system 48 and the seed transportation system 44.

The pressure differential device 14 may be powered electronically, mechanically, hydraulically, or the like. Regardless of how the pressure differential device 14 is powered, the pneumatic system 48 will include air conduits 50 that extend from the pressure differential device 14 to each of the seed meters 38. The air conduits 50 may comprise piping, tubing, hose, conduits, or the like, and are operable to facilitate the flow of air from the pressure differential device 14 to the seed meters 16. As shown in FIGS. 7 and 8, the air conduits 50 may direct air to/from each of the first air inlet 36 and/or the second air inlet 38 of each the seed meters 38. As such, the pneumatic system 48 may include a plurality of individual air conduits 50 for directing air to/from each of the seed meters 38.

The operation of the seed meters 38 is further described in U.S. Pat. App. Pub. No. 2018/0338410, the disclosure of which is incorporated herein by reference in its entirety.

As the metering discs rotate within the seed meters 38, seeds are captured by the seed pockets, and carried along the rotation of the metering discs. The seeds may be retained in the seed pockets via an air-pressure differential provided by the pressure differential device 14 via the air conduits 50.

In one or more embodiments, an electro-mechanical control system comprising a processor, microprocessor, microcontroller, memory elements, and/or the like is used to control the seed meters 38. For instance, a control system may be provided and operable to selectively control the rotation of the metering discs in the seed meters 38. In some embodiments, the control system may be directed manually by manual inputs, such as by buttons, knobs, switches, or the like. In other embodiments, the control system is directed automatically by one or more automated and/or sensory inputs. Such automated inputs may include for instance: timers/clocks, global positioning system (GPS), temperature sensor, moisture sensor, soil-type sensors, bin fill level, soil fertility sensors, soil pH sensors, or the like. Furthermore, the control system may also be able to control the rate at which the seeds are dispensed from the seed meter 38.

### Image Sensors

Turning back to FIGS. 1-6, 8, and 11, the seeding implement 10 may utilize an image sensor 26 to analyze and monitor seed bounce caused during seed disbursement by the implement.

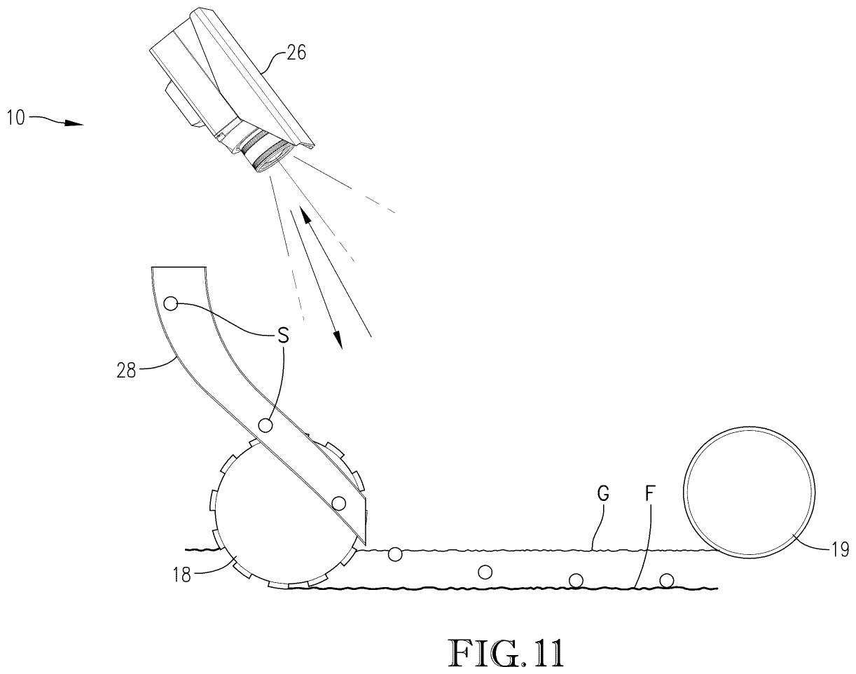

As shown in FIG. 11, the agricultural seeding implement 10 is configured to deposit seeds S into a series of furrows F formed in the ground G and extending uniformly along a field. Embodiments of the seeding implement 10 may also be configured to deposit seeds at different planting depths and/or spacing.

As previously noted, the seeding implement 10 may be pulled across a field (which may include one or more sections of soil) to deposit seed within furrows. The implement 10 is preferably advanced by a towing vehicle (not shown in FIG. 11), such as a tractor. In various embodiments, the towing vehicle may include an operator-driven vehicle or an autonomous vehicle for advancing the implement. In general, embodiments of the implement 10 are preferably towed behind the vehicle, although features of the implement may be alternatively located relative to the vehicle (e.g., to one side of the vehicle or in front of the vehicle).

Turning again to FIG. 11, the seed implement 10 is configured to deposit seeds S into the furrow F via the seed dispensing tube 28 adjacent the coulter blades 18. In the usual manner, the seed tube 28 presents an outlet located laterally between the coulter blades 18 so that seeds S are directed into the furrow F. Additionally, as noted above, the seeding implement 10 includes at least one image sensor 26. Specifically, embodiments of the present invention may use a sensor 26, such as a camera, capable of obtaining information regarding the positioning of the seeds S in relation to the furrows F. Although depicted in FIG. 11 as monitoring a single furrow F, the image sensor 26 may monitor two or more furrows at the same time due to the high placement of the sensor 26 on the frame 22 of the seeding implement 10 (see FIG. 2). At this vantage point, the image sensor 26 is capable of monitoring a plurality of furrows being formed and planted by the seeding implement 10. As shown in FIG. 7, the seeding implement may contain two image sensors 26, with one positioned and monitoring the left half of the seeding implement 10, while the other is positioned and monitoring the right half of the seeding implement 10. Although FIG. 7 depicts the seeding implement having only have two image sensors 26, it is envisioned that the seeding implement may only have one image sensor 26 or more than two image sensors 26. For example, the seeding implement may have at least three, four, five, or six image sensors 26.

In one or more embodiments, each image sensor 26 may be configured to obtain information indicative of one or more furrow parameters of the furrow F. Additionally, or in the alternative, each image sensor 26 is operable to obtain information indicative of one or more seed parameters of seed S deposited into the furrow F. Within the scope of the present invention, one or more sensors 26 may be oriented to look rearwardly toward the rear of the furrow opening where the furrow is closed over the seed S. This rearward orientation of the sensor 26 permits the sensor 26 to see whether the seed S is positioned within the furrow F, or if the seed has “bounced” out of the furrow F.

Seed parameters may also include a number of seeds S deposited in the furrow, a velocity of seeds S deposited in the furrow, an impact position of seeds S deposited in the furrow, and a final resting position of seeds S deposited into the furrow. A seed skip is preferably identified when the measured seed spacing dimension between adjacent seeds is greater than a target seed spacing dimension. For instance, a seed skip may be identified if the measured seed spacing dimension is at least twice the target seed spacing dimension. A seed double is preferably identified when the measured seed spacing dimension between adjacent seeds is less than a target seed spacing dimension. For instance, a seed double may be identified if the measured seed spacing dimension is less than one half the target seed spacing dimension.

Embodiments of the present invention may, additionally or alternatively, have image sensors 26 that include a sensor comprising an array of sensing pixels to determine the location (e.g., depth and/or spacing) of objects in 3D space, such as a time-of-flight camera, LiDAR sensors, radar sensors, ultrasonic sensors, and/or sonar sensors. Each image sensor 26 is configured to generate time-of-flight images of the furrow F and of the seeds S deposited in the furrow F. Each image sensor 26 is further configured to monitor positions of non-seed objects, which may include fertilizer pellets, pesticide pellets, or nutrient pellets.

In one or more embodiments, the image sensor 26 may comprise a time-of-flight camera. The time-of-flight camera may preferably use monochromatic illumination and/or multi-wavelength illumination. The time-of-flight camera may also preferably operate in the UV spectrum, the infrared spectrum, and/or the visible spectrum. In certain embodiments, a preferred camera may use LED light sources and/or LASER light sources. Additionally, or in the alternative, a preferred camera may include photo-detection elements.

Time-of-flight (e.g., LiDAR) ranging technology can be used to gather the spatial data on seeds S during the planting process. The principles of time-of-flight imaging may use either monochromatic or multi-wavelength artificial illumination in the UV through the infrared (IR) range. LASER illumination and LED illumination may comprise preferred light sources for depth measurements and may be used with passive photo-detection sensors. Distances of light-reflective surfaces can be determined by measuring the time between the illuminated source turning on and the delay before reflected light returns to photo-detection sensors, using the speed of light as a fixed reference.

In one or more embodiments, or more of the image sensors 26 may also include or be associated with an RBG camera configured to obtain RGB images of the seeds and/or of the furrow.

Seed objects may be located in camera images using: (i) human crafted, traditional machine vision algorithms, and (ii) deep-learning, neural network methods of computer-optimized algorithms for object detection. These algorithms are configured to be processed by the controller, which may include an electronic control unit (ECU) computer, as described below.

In one or more embodiments, the image sensor 26 provides a depth camera to determine object location (e.g., depth and/or spacing) and distance relative to other objects. Object location and distance data from the sensor 26 can be used to build a matrix of depth values corresponding to pixels on the camera array (which is generally known as a depth map). Applications include seed counting, seed location measurements during planting process, seed velocity, and impact at soil (e.g., to determine whether the seed bounces and/or lands at a desired location). Furrow depth, width, and angle may also be configured to be measured throughout the planting process.

Embodiments of the present invention may utilize near-infrared depth mapping based on time-of-flight to generate feedback for seed planting. The depth maps may be overlaid on RGB camera images to distinguish color and provide more data for improving accuracy. Besides time-of-flight, depth maps can also be generated using stereoscopic images (dual cameras) or structured light can achieve similar results, but time-of-flight may be optimal for the present invention's use cases given the state of current depth camera technology.

For the depicted sensors 26 and other sensors associated with the present invention, it will be appreciated that dust, particles, and other contaminants may interfere with sensor operation. For instance, foreign particulate matter may come to rest on a camera lens or hover adjacent to the lens. It is within the ambit of the present invention for the implement to be provided with a powered pneumatic device operable to clear particulate from the camera lens by directing an airflow at or adjacent the lens.

### Controller, User Interface, and Parameters

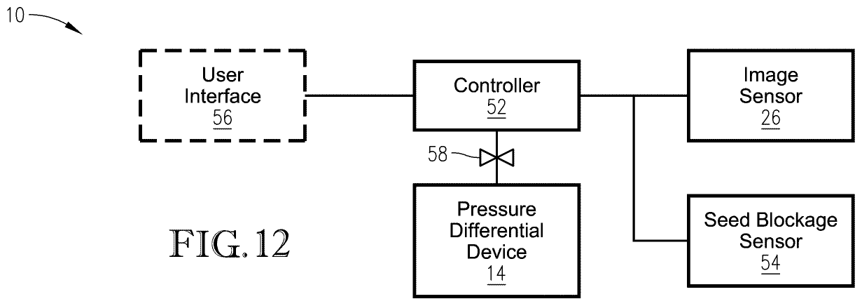

As shown in FIG. 12, the seeding implement 10 may comprise a controller 52 operably coupled to the image sensor 26, the seed flow sensor 54 associated with the seed conduits and/or the seed dispensing tube 28, and an optional user interface 56. Based on the information received from the image sensor 26 and/or the seed flow sensor 54, the controller 52 may manage and control the operation of the pressure differential device 14 via a control valve 58.

In one or more embodiments, the pressure differential device 14 is controlled via a control valve 58 (e.g., a PWM valve, a flap, or a shutter) within the pressure differential device 14, the primary seed conduits 32, the secondary seed conduits 34, the seed conduit 40, and/or the air conduits 50, that is operable to selectively block or allow air to be introduced/removed. In various embodiments, the valve 58 may control the speed and/or power of the pneumatic pump, air compressor, vacuum pump, and/or fan within the pressure differential device 14. In certain embodiments, the valve 58 is a PWM valve that controls the speed and power of a fan within the pressure differential device 14.

In one or more embodiments, the control system 52 is configured to process the information obtained by the image sensors 26 and/or the flow sensor(s) 54 to generate the one or more seed parameters. For instance, the controller 52 may be configured to identify objects in the time-of-flight images received from the sensors. Objects may be identified in the time-of-flight images by various methods, such as machine vision algorithms or deep-learning, neural networks.

In one or more embodiments, the preferred controller 52 may also be configured to generate depth maps based on the time-of-flight images. The depth maps may comprise a matrix of depth values corresponding to pixels of the time-of-flight images. Preferably, the matrix can be used to identify objects and distances between objects.

As described above, in preferred embodiments of the seeding implement 10, the controller 52 is configured to display one or more seed parameters to an operator of the seeding implement 10. The controller 52 is also preferably configured to overlay time-of-flight image data onto other images, such as RGB images from an RGB camera. The controller 52 is also configured to generate an alert if the seed parameters exceed target parameters.

In one or more embodiments, the control system 52 is directed manually by manual inputs, such as by buttons, knobs, switches, or the like. In other embodiments, the control system 52 is directed automatically by one or more automated and/or sensory inputs from the image sensor(s) 26 and/or the seed flow sensor(s) 54. Such sensory inputs may include for instance: timers/clocks, seed blockage within conduits 32 or tube 28, GPS, seed placement in the furrows, or the like. In such instances, when the sensory inputs receive a particular input, the control system 52 directs the control valve 58 to manage the power and operation of the pressure differential device 14. For example, if the seed flow sensor 54 detects a blockage in the seed conduit 32, the controller 52 can increase power within the power differential device 14 in order to clear out this blockage.

In one or more embodiments, the controller 52 is configured to automatically control operation of one or more components of the seeding implement 10 based on the one or more seed parameters. In preferred embodiments, the controller 52 is configured to automatically control operation parameters of the seeding implement 10, including a speed of the seeding implement, a seed distribution timing of the seeding implement, and/or modifying the speed and power of the pressure differential device 14. Modification of the speed and power of the pressure differential device 14 can be controlled via the control valve 58 associated with the device 14.

With the seeding implement 10 of the present invention, information on the planting process can be actively monitored as the process continues. A range of tolerances may be set such that the system informs the operator if the planting depth and spacing exceeds specifications at any point in the planting process. Video images may also be presented to the operator (e.g., showing seed placement during planting).

In one or more embodiments, the seeding implement 10 also includes a user interface 56 operably coupled to the controller 52 and configured to display one or more seed parameters and/or furrow parameters to an operator of the seeding implement (see FIG. 12). Generally, an alert may be displayed to the operator (e.g., via the user interface 56) if a seed parameter exceeds a corresponding target parameter value or range and/or if there is blockage within the seed conduits and/or seed tube 28.

The user interface 56 may provide a list of measured data and include data label indicia and data indicia. The data indicia preferably present sensor data associated with the aforementioned sensor measurements. In one or more embodiments, it is within the scope of the present invention for the controller 52 and user interface 56 to be provided as part of a computing device of the implement 10. All or some components of the computing device may be located in the cab of the towing vehicle or otherwise associated with the towing vehicle.

The preferred user interface 56 will have an electronic display, such as a cathode ray tube, liquid crystal display, plasma, or touch screen that is operable to display visual graphics, images, text, etc. In certain embodiments, the computer program associated with the user interface 56 facilitates interaction and communication through a graphical user interface (GUI) that is displayed via the electronic display. The GUI enables the user to interact with the electronic display by touching or pointing at display areas to provide information to the user interface 56. In additional preferred embodiments, the computing device may also include an optical device such as a digital camera, video camera, optical scanner, or the like, such that the computing device can capture, store, and transmit digital images and/or videos.

The controller 52 is preferably operable to determine if the information provided by the image sensor(s) 26 and/or the seed flow sensor(s) 54 matches a target value of the seed parameters. The operator may also be alerted (e.g., via the user interface 56) if one or more seed parameters detected by the image sensor(s) 26 and/or the seed flow sensor(s) 54 are not met.

The described alerts are preferably provided to the operator via the user interface 56 so that the operator may take action (e.g., by making adjustments to the pressure differential device 14) to facilitate continued implement operation or to halt implement operation. However, it will also be understood that the controller 52 may be configured to automatically control the seeding implement 10 and take action to facilitate continued implement operation or to halt implement operation without operator intervention.

When seeds S enter the furrow, the seeding implement 10 is configured to detect seeds S and measure the depth relative to the top of the furrow, allowing planting depth to be quantified. Similarly, embodiments can measure the distance between seeds (spacing of seeds) and detect suboptimal planting performance of a row unit. The operator may be alerted by the user interface 56 (or another device) to parameters including: missed seeds (skips), added seeds (doubles), poor spacing, and/or seeds not detected in the furrow F. Similar measurements and operator alerts may also be provided for other seed-like objects, such as fertilizer pellets.

In one or more embodiments, the controller 52 and user interface 56 may be provided as part of a computing device of the implement 10. The computing device may include any device, component, or equipment with a processing element and associated memory elements. The processing element may implement operating systems, and may be capable of executing a computer program, which is also generally known as instructions, commands, software code, executables, applications (“apps”), and the like. The processing element may include processors, microprocessors, microcontrollers, field programmable gate arrays, and the like, or combinations thereof. The memory elements may be capable of storing or retaining the computer program and may also store data, typically binary data, including text, databases, graphics, audio, video, combinations thereof, and the like. The memory elements may also be known as a “computer-readable storage medium” and may include random access memory (RAM), read only memory (ROM), flash drive memory, floppy disks, hard disk drives, optical storage media such as compact discs (CDs or CDROMs), digital video disc (DVD), Blu-Ray™, and the like, or combinations thereof.

The computing device may specifically include an electronic control unit (ECU) computer, mobile communication devices (including wireless devices), workstations, desktop computers, laptop computers, palmtop computers, tablet computers, portable digital assistants (PDA), smart phones, and the like, or combinations thereof. Various embodiments of the computing device may also include voice communication devices, such as cell phones or landline phones.

The user interface 56 of the computing device may enable one or more users to share information and commands with one or more other computing devices (such as the computing device of another implement). The user interface 56 may facilitate interaction through the GUI described above or may additionally comprise one or more functionable inputs such as buttons, keyboard, switches, scrolls wheels, voice recognition elements such as a microphone, pointing devices such as mice, touchpads, tracking balls, styluses. The user interface 56 may also include a speaker for providing audible instructions and feedback. Further, the user interface 56 may comprise wired or wireless data transfer elements, such as a communication component, removable memory, data transceivers, and/or transmitters, to enable the user and/or other computing devices to remotely interface with the computing device of the implement 10.

It is also within the ambit of the present invention for the computing device of implement 10 to be associated with other computing devices and/or server devices via a communications network. For instance, the computing device of implement 10 may be operable to communicate with a computing device of one or more other implements via the communications network. The communications network may be wired or wireless and may include servers, routers, switches, wireless receivers and transmitters, and the like, as well as electrically conductive cables or optical cables. The communications network may also include local, metro, or wide area networks, as well as the Internet, or other cloud networks. Furthermore, the communications network may include cellular or mobile phone networks, as well as landline phone networks, public switched telephone networks, fiber optic networks, or the like.

Turning again to FIG. 12, during operation of the implement 10, seed information from the image sensor(s) 26, such as placement of seed distributed from the seed tube 28 on the ground relative to the position of the furrow, and seed information from the seed flow sensor(s) 54, such as flow rates through the seed conduits and/or seed tube, may be conveyed to the controller 52 and the user interface 56. Based on this seed information from the image sensor(s) 26 and the seed flow sensor(s) 54, the controller can manage the operation and power of the pressure differential device 14 via the control valve 58. For example, if the image sensor(s) 26 detect excessive seed bounce (i.e., the seeds bouncing out of the furrows during application), then the controller 52 can relay instructions to the control valve 58 to decrease the speed and power of the pressure differential device 14, so that the seeds can be released from the impellent at a slower rate, thereby mitigating seed bounce. In another example, if the seed flow sensor(s) 54 detect blockage or lack of seed flow within the seed conduits and/or seed tube, then the controller 52 can relay instructions to the control valve 58 to increase the speed and power of the pressure differential device 14, so that the air velocity within the conduits is increased, thereby removing the blockage.

### Definitions

It should be understood that the following is not intended to be an exclusive list of defined terms. Other definitions may be provided in the foregoing description, such as, for example, when accompanying the use of a defined term in context.

As used herein, the terms “a,” “an,” and “the” mean one or more.

As used herein, the term “and/or,” when used in a list of two or more items, means that any one of the listed items can be employed by itself or any combination of two or more of the listed items can be employed. For example, if a composition is described as containing components A, B, and/or C, the composition can contain A alone; B alone; C alone; A and B in combination; A and C in combination, B and C in combination; or A, B, and C in combination.

As used herein, the terms “comprising,” “comprises,” and “comprise” are open-ended transition terms used to transition from a subject recited before the term to one or more elements recited after the term, where the element or elements listed after the transition term are not necessarily the only elements that make up the subject.

As used herein, the terms “having,” “has,” and “have” have the same open-ended meaning as “comprising,” “comprises,” and “comprise” provided above.

As used herein, the terms “including,” “include,” and “included” have the same open-ended meaning as “comprising,” “comprises,” and “comprise” provided above.

Directional terms used in the specification, such as the terms “front/forward,” “back/rear/rearward,” “left,” and “right,” are given from the viewpoint of one standing at the rear of the implement looking forward. As such, for example, the implement may include a hitch tongue (not shown) at a front of the implement, extending forward from the main frame, for coupling the implement with the towing vehicle. Furthermore, the implement will generally be configured for movement in a forward travel direction, as the implement is propelled by a towing vehicle. As used herein, the term “longitudinal” will generally refer to a forward and/or rearward direction with respect to the implement. As such, the longitudinal direction is generally parallel with the travel direction. In contrast, the term “lateral” will generally refer to a rightward and/or leftward direction with respect to the implement. As such, the lateral direction is generally perpendicular with the travel direction.

### Numerical Ranges

The present description uses numerical ranges to quantify certain parameters relating to the invention. It should be understood that when numerical ranges are provided, such ranges are to be construed as providing literal support for claim limitations that only recite the lower value of the range as well as claim limitations that only recite the upper value of the range. For example, a disclosed numerical range of 10 to 100 provides literal support for a claim reciting “greater than 10” (with no upper bounds) and a claim reciting “less than 100” (with no lower bounds).

### CLAIMS NOT LIMITED TO DISCLOSED EMBODIMENTS

The preferred forms of the invention described above are to be used as illustration only, and should not be used in a limiting sense to interpret the scope of the present invention. Modifications to the exemplary embodiments, set forth above, could be readily made by those skilled in the art without departing from the spirit of the present invention.

For example, the seeding implement depicted in FIGS. 1-7 distributes seeds from the hoppers to the opener seed tubes via a primary conduit, a distribution manifold/tower, and a secondary conduit. However, it should be understood that certain inventive concepts described and claimed herein can be applied to “direct supply” seeding implements that do not include a primary conduit or a distribution manifold/tower. One example of such a direct supply seeding implement is the Great Plains NTA1300, available from Great Plains Manufacturing Inc. of Salina, Kansas. Direct supply seeding implements have a meter for each row under the hopper with a dedicated line from the meter to the opener seed tube. These direct supply seeding implements can employ the same inventive concepts (e.g., seed bounce detection and airflow control) as described above with reference to the illustrated embodiments.

The inventors hereby state their intent to rely on the Doctrine of Equivalents to determine and assess the reasonably fair scope of the present invention as it pertains to any apparatus not materially departing from but outside the literal scope of the invention as set forth in the following claims.

What is claimed is:

1. A seeding implement for depositing seeds, wherein the seeding implement comprises:
a furrow opener configured to create a furrow in the ground;
a seed distribution assembly configured to deposit seeds in the furrow;
a pressure differential device configured to provide air pressure to the seed distribution assembly;
an image sensor configured to obtain information indicative of one or more seed parameters of the seeds already deposited in the furrow; and
a controller configured to process the information obtained by the image sensor, wherein the controller is further configured to automatically control operation of the pressure differential device based on the one or more seed parameters.

2. The seeding implement according to claim 1, wherein the image sensor comprises a camera.

3. The seeding implement according to claim 1, wherein the pressure differential device comprises a pneumatic pump, an air compressor, a vacuum pump, or a fan.

4. The seeding implement according to claim 3, wherein the pressure differential device comprises a fan.

5. The seeding implement according to claim 1, further comprising a seed flow sensor associated with the seed distribution assembly, wherein the seed flow sensor is configured to obtain flow information indicative of a flow of the seeds within the seed distribution assembly.

6. The seeding implement according to claim 5, wherein the controller is further configured to process the flow information by the seed flow sensor and automatically control operation of the pressure differential device based on the flow information.

7. The seeding implement according to claim 1, further comprising a control element configured to control power of the pressure differential device, wherein the controller automatically controls operation of the control element.

8. The seeding implement according to claim 1, wherein the seeding implement comprises a plurality of furrow openers configured to create a plurality of furrows and a plurality of seed distribution assemblies configured to deposit the seeds into the furrows.

9. The seeding implement according to claim 8, wherein the seeding implement comprises a single image sensor configured to monitor the plurality of furrows.

10. The seeding implement according to claim 1, wherein the seed parameters include a location of the seeds deposited into the furrow.

11. A seeding implement for depositing seeds, wherein the seeding implement comprises:
a furrow opener configured to create a furrow in the ground;
a seed source configured to store seeds;
a seed distribution assembly configured to deposit the seeds in the furrow, wherein the seed distribution assembly comprises a seed conduit operably connected to the seed source, wherein the seed conduit facilitates transportation of the seeds from the seed source;
a seed flow sensor configured to obtain flow information indicative of a flow of the seeds in the seed conduit;
a pressure differential device configured to provide air pressure to the seed distribution assembly, wherein the pressure differential device comprises a pneumatic pump, an air compressor, a vacuum pump, or a fan;
an image sensor configured to obtain seed information indicative of one or more seed parameters of the seeds already deposited in the furrow; and
a controller configured to process the flow information from the seed flow sensor and the seed information from the image sensor, wherein the controller is further configured to automatically control operation of the pressure differential device based on the flow information and the seed information.

12. The seeding implement according to claim 11, wherein the pressure differential device comprises a fan.

13. The seeding implement according to claim 11, further comprising a control element configured to control power of the pressure differential device, wherein the controller automatically controls operation of the control element.

14. The seeding implement according to claim 11, wherein the seeding implement comprises a plurality of furrow openers configured to create a plurality of furrows and a plurality of seed distribution assemblies configured to deposit the seeds into the furrows.

15. The seeding implement according to claim 14, wherein the seeding implement comprises a single image sensor configured to monitor the plurality of furrows.

16. The seeding implement according to claim 11, wherein the seed parameters include a location of the seeds deposited into the furrow.

17. The seeding implement according to claim 11, wherein the image sensor comprises a time-of-flight camera, a LiDAR sensor, a radar sensor, an ultrasonic sensor, or a sonar sensor.

18. The seeding implement according to claim 11, wherein the image sensor comprises a time-of-flight camera.

19. The seeding implement according to claim 11, wherein the seed flow sensor comprises an optical sensor, a time-of-flight camera, a LiDAR sensor, a radar sensor, an ultrasonic sensor, a piezoelectric sensor, an acoustic sensor, or a sonar sensor.

20. A method for mitigating seed bounce during seed application, the method comprising:
(a) applying one or more seeds into a furrow via a seeding implement, wherein the seeding implement comprises—
a furrow opener configured to create the furrow in the ground;
a seed source configured to store seeds;
a seed distribution assembly configured to deposit the seeds in the furrow, wherein the seed distribution assembly comprises a seed conduit operably connected to the seed source, wherein the seed conduit facilitates transportation of the seeds from the seed source;
a blockage sensor configured to obtain flow information indicative of a flow of the seeds in the seed conduit;
a pressure differential device configured to provide air pressure to the seed distribution assembly, wherein the pressure differential device comprises a pneumatic pump, an air compressor, a vacuum pump, or a fan;
an image sensor configured to obtain seed information indicative of one or more seed parameters of the seeds already deposited in the furrow; and
a controller configured to process the flow information from the seed flow sensor and the seed information from the image sensor;
(b) observing the seed bounce during the seed application; and
(c) adjusting the air pressure provided by the pressure differential device based on the observing of step (b).
